(19) United States
(12) Patent Application Publication
(10) Pub. No.: US 2014/0209255 A1
(43) Pub. Date: Jul. 31, 2014

(54) ADJUSTABLE WINDOW TREATMENT SUSPENSION SYSTEM

(71) Applicants: Andre Degiovanni, West Covina, CA (US); Andre Degiovanni, JR., West Covina, CA (US)

(72) Inventors: Andre Degiovanni, West Covina, CA (US); Andre Degiovanni, JR., West Covina, CA (US)

(21) Appl. No.: 14/166,597

(22) Filed: Jan. 28, 2014

Related U.S. Application Data
(60) Provisional application No. 61/757,386, filed on Jan. 28, 2013.

(51) Int. Cl. A47H 1/12; E06B 9/56

(52) U.S. Cl. CPC A47H 1/12; E06B 9/56
USPC 160/84.01

(57) ABSTRACT

An adjustable window treatment system has a valance frame attachable to a wall bordering a window frame, sliding door or opening. A first pulley is attached to one end of the valance frame and second and third pulleys attached to an opposite end of the valance frame. An attachment frame is suspended relative to the support frame via pulley cords that engage the pulleys. The attachment frame has hooks that couple to a curtain removably attachable to the attachment frame, the hooks being slidable relative to the attachment frame to allow the curtain to slide to one or both sides of the attachment frame to open the curtain. The attachment frame is movable from a raised position where it is disposed behind the face plate and a lowered position via actuation of the pulley cords by a user, thereby allowing the user to detach a curtain from the attachment frame without using a ladder or chair to remove the curtain.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of U.S. Provisional Application No. 61/757,386, filed Jan. 28, 2013 and titled AJUSTABLE WINDOW TREATMENT SUSPENSION SYSTEM, the entirety of which is incorporated by reference and should be considered a part of this specification.

### BACKGROUND

1. Field

The invention relates to window treatments and more particularly to adjustable suspension system for window treatments, such as curtains.

2. Description of the Related Art

Window treatments for privacy and security are known in the art, including shades, blinds and curtains. Since window treatments are customarily hung from the top of a window, and because windows may extend out of reach in many instances, users must often employ a ladder or chair to reach a curtain rod or other device from which window treatments are hung. Due to the frequency with which users remove window coverings for either cleaning or replacement, a persistent hazard of injury from falling exists.

### SUMMARY

There is therefore a need for a window treatment suspension system that avoids the need for users to employ a ladder, a chair, or reach up while standing in an otherwise precarious position. In accordance with one aspect of the present invention, an adjustable window treatment suspension system is provided that allows users to reach the attachment mechanism of a window treatment from a standing or even sitting position. These and other objects of the invention will be further described in the following detailed description and illustrations.

In accordance with one embodiment, an adjustable window treatment suspension system is provided. The system comprises a support frame attachable to a wall and bordering a window frame, sliding door frame or opening. The support frame has a support plate attachable to the wall, a cross-bar attached to the support plate and extending outward therefrom, and a face plate attached to the cross-bar and extending downward therefrom. A first pulley is attached to one end of the support frame and second and third pulleys attached to an opposite end of the support frame. The system also comprises an attachment frame suspended relative to the support frame via pulley cords that engage the first, second and third pulleys, the pulley cords comprising a first pulley cord secured to one end of the attachment frame that engages the first and second pulleys and a second pulley cord secured to an opposite end of the attachment frame that engages the third pulley. The attachment frame has one or more coupling members configured to couple to one or more connection elements of a curtain removably attachable to the attachment frame via the coupling members. The one or more coupling members are slidable relative to the attachment frame to allow at least a portion of the curtain to slide to one side of the attachment frame to allow a user to view through the window, sliding door or opening. The attachment frame is movable from a raised position where it is disposed behind the face plate and one or more lowered positions via actuation of the pulley cords by a user, thereby allowing the user to detach a curtain from the attachment frame while in a seated or normal standing position and without using a ladder or chair to remove the curtain.

In accordance with another embodiment, an adjustable window treatment suspension system is provided. The system comprises a valance frame attachable to a wall bordering a window frame, the valance frame having a support plate attachable to the wall, a cross-bar attached to the support plate and extending outward therefrom, and a face plate attached to the cross-bar and extending downward therefrom. A first pulley is attached to one end of the valance frame and second and third pulleys attached to an opposite end of the valance frame. The system also comprises an attachment frame suspended relative to the valance frame via pulley cords that engage the first, second and third pulleys, the pulley cords comprising a first pulley cord secured to one end of the attachment frame that engages the first and second pulleys and a second pulley cord secured to an opposite end of the attachment frame that engages the third pulley. The attachment frame has one or more hooks configured to couple to a curtain removably attachable to the attachment frame via the one or more hooks, the one or more hooks being slidable relative to the attachment frame to allow at least a portion of the curtain to slide to one side of the attachment frame to allow a user to view through the window. The attachment frame is movable from a raised position where it is disposed behind the face plate and one or more lowered positions via actuation of the pulley cords by a user, thereby allowing the user to detach a curtain from the attachment frame without using a ladder or chair to remove the curtain.

### BRIEF DESCRIPTION OF THE DRAWINGS

Other features and advantages of the present invention will be apparent from the following detailed description of the invention, taken in conjunction with the accompanying drawings of which:

FIG. 1 is a schematic front view of one embodiment of an adjustable window treatment suspension system.

FIG. 2 is a schematic partial perspective view of the adjustable window treatment suspension system of FIG. 1.

FIG. 3 is a schematic side view of the adjustable window treatment suspension system of FIG. 1.

### DETAILED DESCRIPTION

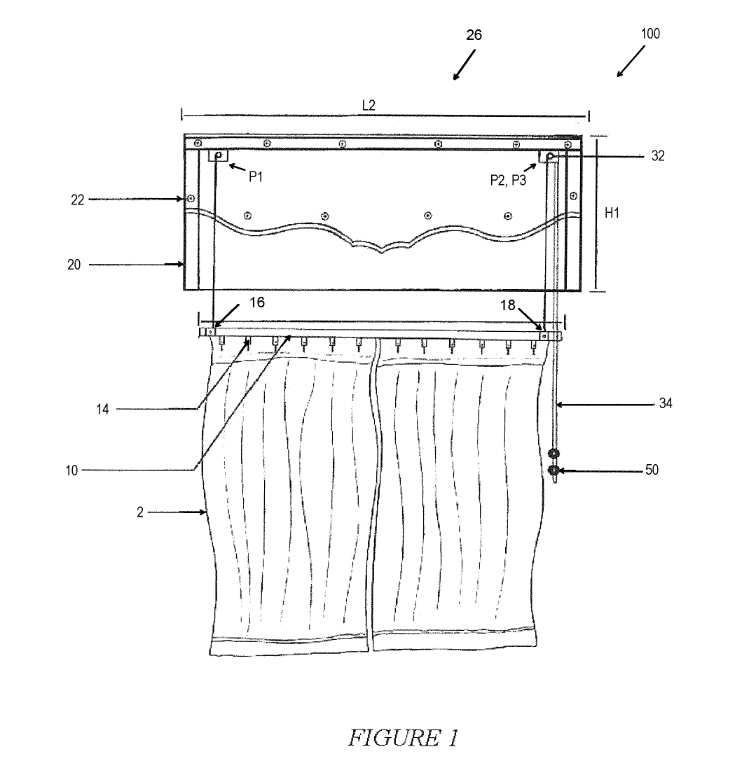

FIGS. 1-3 show one embodiment of an adjustable window treatment suspension system 100. The figures are schematic and are not drawn to scale. The system 100 can include an attachment frame 10 that can have one or more hooks 14 (e.g. a plurality of hooks 14) from which a curtain 2 (or other window treatment) can be suspended. Although the illustrated embodiment shows the curtain 2 (or window treatment) coupled to the frame 10 via hooks 14, other suitable mechanisms (e.g. hoop and loop attachment mechanism, such as Velcro) can be used to attach the curtain 2 (or window treatment) the frame 10. The one or more hooks 14 can be incorporated into the attachment frame 10. In one embodiment the attachment frame 10 is made of metal. In other embodiments, the attachment frame 10 can be made of other suitable materials (e.g., plastic). The hooks 14 can engage the attachment frame 10 in a sliding manner, such as by sliding long a track 12, thus permitting the curtain 2 (or window treatment) to slide left or right along the frame 10 according to a user's preference, as with conventional curtains.

The attachment frame 10 can be of any dimension suitable for a particular curtain installation (e.g., have a length suitable for the particular size of, for example, the window or slider door that it will be used with). In one embodiment, the attachment frame 10 can have a length L1 of about 66¾ inches and a width of about one inch. The attachment frame 10 can also have pulley cord attachment points 16, 18 near each end of the frame 10 for attaching a pulley cord 32, 34, from which the attachment frame 10 will depend. The pulley cords 32, 34 can extend upward from the attachment frame 10, to engage pulleys P1, P2, P3 aligning with the left and right sides, respectively, of the attachment points 16, 18. The pulleys P1, P2, P3 can be supported on a support frame 20 (e.g., on a cross-member 28 of the support frame 20), which can be attached to a support surface (e.g., wall W surrounding the window or slider door) via one or more fasteners 22 (e.g., screws, nails, bolts). In the illustrated embodiment, the pulley cord 32 engages a third pulley P3 and attaches to the attachment frame 10 at attachment point 18; the pulley cord 32 extends downward from the third pulley P3 to one or more attachment members 50 attached to a support surface (e.g., a wall W). Similarly, the pulley cord 34 attaches to the attachment frame 10 at attachment point 16, then extends upward to engage a first pulley P1, then extends across a width of the support frame 20, supported by one or more support members 24 (e.g., hooks), and engages a second pulley P2, after which the pulley cord 34 extends downward to the one or more attachment members 50. In the illustrated embodiment, two attachment members 50 are attached to a support surface (e.g., the wall W) with a fastener 52 (e.g., a screw, bolt, nail, etc.). In one embodiment, each of the pulley cords 32, 34 can be attached to separate attachment members 50. In another embodiment, the pulley cords 32, 34 can both be attached to the same attachment member 50.

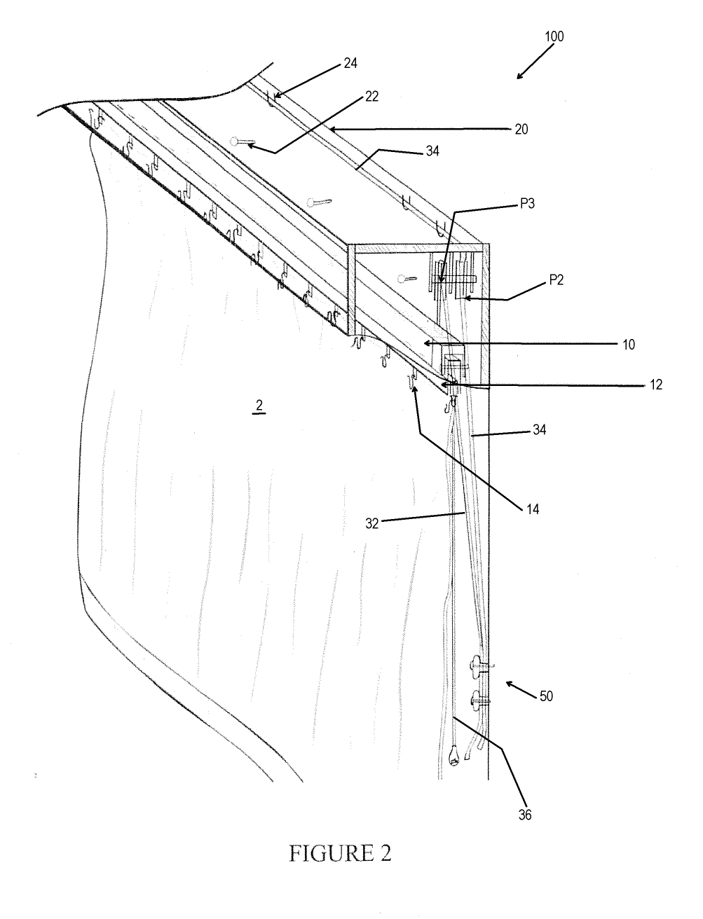

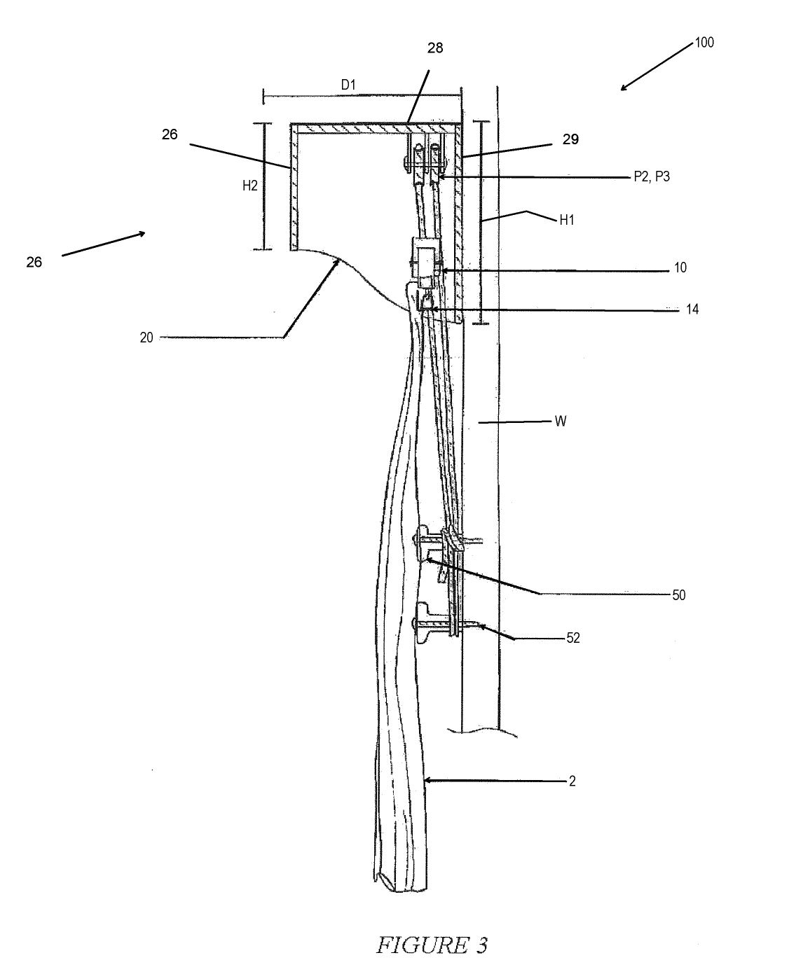

As best seen in FIGS. 2 and 3, the left (e.g., first) pulley P1 and right (e.g., second and third) pulleys P2, P3 are preferably obscured behind face plate 27 of a valance 26 or similar structure that is attached to the cross member 28 of the support frame 20, where the cross-member 28 is itself attached to a support plate 29 of the support frame 20 that can be attached to the support surface (e.g., wall W), as discussed above. In one embodiment, the support plate 29 can have a height H1 greater than a height H2 of the face plate 27. In one embodiment, the cross-member 28 can have a width D1. The valance 26 can advantageously hide one or more mechanical details of the suspension system 100 from line of sight or users (e.g., people in the room where the system 100 is). In one embodiment, the valance 26 can hide the one or more pulleys P1, P2, P3, as well as the attachment frame 10 when the frame 10 is in the completely raised position. In one embodiment, the valance 26 can advantageously protect the pulleys P1, P2, P3 and pulley cords 32, 36 from interference. As shown in FIG. 1, the valance 26 can be longer than the attachment frame 10 (e.g., have a length L2 that is longer than the length L1 of the attachment frame 10 by, for example, about two inches). In one embodiment, the valance 26 can be made of wood. In use, the attachment frame 10 can be disposed behind the face plate 27 when the curtain 2 is installed, fully raised and in use.

In one embodiment, the pulley cords 32, 34 can have variable lengths, allowing one pulley cord 34 to extend across the valance 26, such that both pulley cords 32, 34 are located on a single side of a window, slider door or opening that the curtain 2 is used to cover when installed. As discussed above, one or more attachment members 50, cord retainers, string attachments, or tensioners can be disposed on the wall W (or support surface) adjacent the window, slider door or opening for anchoring the pulley cords 32, 34 in place, thereby holding the attachment frame 10 (to which the curtain 2 or window treatment is attached) inside the valance 26 and hidden behind the face plate 27.

Referring to FIGS. 2 and 3, a perspective view of the adjustable window treatment suspension system 100 is shown. In this view, a curtain 2 is shown suspended from hooks 14 that removably engage the attachment frame 10. Also shown is a cord 36 that can be adjusted by a user (e.g., by pulling on the cord 36) to adjust the curtain 2. In one embodiment, the cord 36 can be actuated (e.g., pulled on) to pull the curtains 2 to one side, or towards each side (e.g. by opening from the middle outward) of the attachment frame 10 for revealing the window, slider door or opening covered by the attachment frame 10 (e.g., by pulling on at least one of the one or more hooks 14 or a slidable track member on which the hooks 14 are carried, or for raising and lowering the curtain (e.g., by an inner frame 12 relative to the attachment frame 10), in a manner similar to venetian blinds. The one or more hooks 14 can slide relative to the attachment frame 10 using suitable mechanisms (e.g., a track on which the hooks 14 slide or a slideable track that mores relative to the attachment frame 10, at least one of the hooks 14 rigidly attached to the slidable track, wherein sliding of said at least one hook 14 causes the rest of the hooks 14 to slide).

Still referring to FIGS. 2 and 3, the pulley cords 32, 34 are shown depending from pulleys P2, P3 installed near one end of the valance 26. The second pulley P2, closest to the rear of the valance 26, engages a pulley cord 34 extending from the attachment frame 10 at the far side of the valance 26, via the first pulley P1 and through a series of support members or guides 24, and the third pulley P3, in front of the second pulley P2, engages the pulley cord 32 extending from the opposite side (e.g., near side in FIG. 2) of the attachment frame 10. Both pulley cords 32, 34 can come together at the second and third pulleys P2, P3 and depend downward, to engage the one or more attachment members 50 to hold the pulley cords 32, 34 taught, thereby holding the curtain 2 in an installed position. In one embodiment, the one or more attachment members 50 can be a set of pegs.

As discussed above, the pulleys P1, P2, P3 are installed on the top of the valance 26. As shown in FIG. 1, a pulley (first pulley) P1 is also installed at the top of the valance 26 at its opposite end (e.g., left end on FIG. 1). Although the valance 26 shown has only a back member or support plate 29 attached to a wall W, a top or cross-member 28, and a front member or face plate 27 for obscuring the mechanics of the adjustable window treatment suspension system 100, in other embodiments, the valance 26 may optionally include side members (not shown) to further obstruct the view of the pulleys P1, P2, P3 and at least a portion of the pulley cords 32, 34 from a line of sight of a user.

In use, the user can detach the pulley cords 32, 34 from the attachment members 50 and lower the attachment frame 10, again attach the pulley cords 32, 34 once the attachment frame 10 has been lowered to within reach of the user, thereby allowing the user to remove the curtain 2 (or window treatment) from the attachment frame 10 (e.g., by removing the curtain 2 from the hooks 14). The user can then replace the curtain 2 with another curtain or window treatment, or can launder the curtain 2. The replacement curtain 2 can then be attached to the attachment frame 10 (e.g., by attaching the curtain 2 to the hooks 14 of the attachment member 10) and the user can pull on the pulley cords 32, 34 to raise the attachment frame 10 behind the face plate 27 of the valance 26. Once in the raised position, the user can securely attach the pulley cords 32, 34 to the one or more attachment members 50 to hold the attachment frame 10 in the raised position. The user can actuate the cord 36 (e.g., by pulling it) to open the curtain 2 to allow a user to view through the window, slider door or opening covered by the curtain 2. As discussed above, the curtain can be pulled completely to one side of the attachment frame 10 or can open from the middle outward so that portions of the curtain 2 are pulled to both sides of the attachment frame 10.

Though embodiments above describe the hooks 14 as attached to the attachment frame 10 and the curtain 2 attaching to the hooks 14 (e.g., via holes in the curtain 2), in other embodiments, the hooks 14 can be disposed on the curtain and the attachment frame 10 can have a plurality of holes that can receive the hooks 14 to couple the curtain 2 to the attachment frame 10, said holes formed on a slidable track that can allow the user to open the curtain 2 once installed by pulling on the cord 36 as discussed above.

Advantageously, the system 100 allows a user to easily remove curtains 2 (or window treatments) from the attachment member 10 while seated or standing without having to reach up to the top of the window, slider door or opening. Accordingly, the user can avoid having to use a ladder, chair or reach precariously for the top of the window to remove a curtain 2 or window treatment for replacement or laundering, thereby inhibiting injury to the user. The system 10 can advantageously allow users of all capabilities (e.g., incapacitated and in a wheel chair, elderly) to operate the system 10 easily remove and replace curtains 2 or window treatments from a window frame assembly.

Although the present specification describes a manual pulley based system for adjusting the position of the attachment frame 10 relative to the support frame 20, in other embodiments, the attachment frame 10 can be moved relative to the support frame 20 via a motorized or electric system (e.g., using one or more electric motors that rotate the one or more pulleys P1, P2, P3 or that pull on or extend the pulley cords 32, 34 to raise or lower the attachment frame 10 relative to the support frame 20.

Although the present specification shows and describes a preferred embodiment of the adjustable window treatment suspension system, it is anticipated that other embodiments are possible, inasmuch as the invention has been described by way of example and not limitation. Thus, it is intended that the present description cover the modifications and variations of the apparatus and method provided they come within the scope of the appended claims and their equivalents.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. An adjustable window treatment suspension system, comprising:
a support frame attachable to a wall and bordering a window frame, sliding door frame or opening, the support frame having a support plate attachable to the wall, a cross-bar attached to the support plate and extending outward therefrom, and a face plate attached to the cross-bar and extending downward therefrom, a first pulley attached to one end of the support frame and second and third pulleys attached to an opposite end of the support frame; and
an attachment frame suspended relative to the support frame via pulley cords that engage the first, second and third pulleys, the pulley cords comprising a first pulley cord secured to one end of the attachment frame that engages the first and second pulleys and a second pulley cord secured to an opposite end of the attachment frame that engages the third pulley, the attachment frame having one or more coupling members configured to couple to one or more connection elements of a curtain removably attachable to the attachment frame via the coupling members, the one or more coupling members being slidable relative to the attachment frame to allow at least a portion of the curtain to slide to one side of the attachment frame to allow a user to view through the window, sliding door or opening,
wherein the attachment frame is movable from a raised position where it is disposed behind the face plate and one or more lowered positions via actuation of the pulley cords by a user, thereby allowing the user to detach a curtain from the attachment frame while in a seated or normal standing position and without using a ladder or chair to remove the curtain.

2. The system of claim 1, wherein the one or more coupling members comprise hooks configured to couple to the curtain.

3. The system of claim 1, further comprising a cord acutatable by the user to slide the coupling members relative to the attachment frame to allow at least a portion of the curtain to slide to one side of the attachment frame to allow a user to view through the window, sliding door or opening.

4. The system of claim 1, further comprising one or more pegs attachable to the wall, the one or more pegs configured to secure the pulley cords to hold the attachment frame in a desired position.

5. The system of claim 1, wherein the first pulley cord extends along a length of the support frame.

6. The system of claim 1, wherein a length of the support frame is greater than a length of the attachment frame.

7. The system of claim 1, wherein the first, second and third pulleys are attached to the cross-member of the support frame.

8. The system of claim 1, wherein the second and third pulleys are aligned along the same axis.

9. An adjustable window treatment suspension system, comprising:
a valance frame attachable to a wall bordering a window frame, the valance frame having a support plate attachable to the wall, a cross-bar attached to the support plate and extending outward therefrom, and a face plate attached to the cross-bar and extending downward therefrom, a first pulley attached to one end of the valance frame and second and third pulleys attached to an opposite end of the valance frame; and
an attachment frame suspended relative to the valance frame via pulley cords that engage the first, second and third pulleys, the pulley cords comprising a first pulley cord secured to one end of the attachment frame that engages the first and second pulleys and a second pulley cord secured to an opposite end of the attachment frame that engages the third pulley, the attachment frame having one or more hooks configured to couple to a curtain removably attachable to the attachment frame via the one or more hooks, the one or more hooks being slidable relative to the attachment frame to allow at least a portion of the curtain to slide to one side of the attachment frame to allow a user to view through the window,
wherein the attachment frame is movable from a raised position where it is disposed behind the face plate and one or more lowered positions via actuation of the pulley cords by a user, thereby allowing the user to detach a curtain from the attachment frame without using a ladder or chair to remove the curtain.

10. The system of claim 9, further comprising a cord acutatable by the user to slide the one or more hooks relative to the attachment frame to allow at least a portion of the curtain to slide to one side of the attachment frame to allow a user to view through the window.

11. The system of claim 9, further comprising one or more pegs attachable to the wall, the one or more pegs configured to secure the pulley cords to hold the attachment frame in a desired position.

12. The system of claim 9, wherein the first pulley cord extends along a length of the valance frame.

13. The system of claim 9, wherein a length of the valance frame is greater than a length of the attachment frame.

14. The system of claim 9, wherein the first, second and third pulleys are attached to the cross-member of the valance frame.

15. The system of claim 9, wherein the second and third pulleys are aligned along the same axis.
